(19) United States
(12) Patent Application Publication
(10) Pub. No.: US 2008/0030649 A1
(43) Pub. Date: Feb. 7, 2008

(54) HYBRID DIFFUSION PLATE, BACKLIGHT ASSEMBLY HAVING HYBRID DIFFUSION PLATE, AND LIQUID CRYSTAL DISPLAY HAVING BACKLIGHT ASSEMBLY

(75) Inventors: Yong-seok CHOI, Yongin-si (KR); Jin-ho CHO, Cheonan-si (KR); Chul-woo LEE, Asan-si (KR); Sung-hun LEE, Masan-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD.,, Suwon-si (KR)

(21) Appl. No.: 11/833,388

(22) Filed: Aug. 3, 2007

(30) Foreign Application Priority Data
Aug. 4, 2006 (KR) 1020060073929

(51) Int. Cl. G02B 5/02; F21V 9/00; G02F 1/13357

(52) U.S. Cl. 349/64; 156/99; 362/355

(57) ABSTRACT

A hybrid diffusion plate includes a plurality of sub diffusion plates facing one another and diffusing light, heat-insulating layers having heat conductivity lower than the sub diffusion plates and respectively interposed between each pair of adjacent sub diffusion plates, and a sealant applied between each pair of adjacent sub diffusion plates along an edge and bonding the sub diffusion plates to each other.

This application claims priority to Korean Patent Application No. 10-2006-0073929 filed on Aug. 4, 2006, and all the benefits accruing therefrom under 35 U.S.C. §119, the contents of which are incorporated herein by reference in its entirety.

### BACKGROUND OF THE INVENTION

1. Field of the Invention

The present invention relates to a hybrid diffusion plate, a back-light assembly having the hybrid diffusion plate, and a liquid crystal display having the back-light assembly, more particularly, the present invention relates to a hybrid diffusion plate, a back-light assembly having the hybrid diffusion plate, and a liquid crystal display having the back-light assembly such that when a plurality of lamps are used as a light source, prevent heat generated by the lamps from being transferred to a liquid crystal panel.

2. Description of the Related Art

Liquid crystal displays are widely used as one of flat panel displays. A liquid crystal display includes two substrates having electrodes thereon and a liquid crystal layer interposed therebetween. When a voltage is applied to the electrodes, liquid crystal molecules of the liquid crystal layer are rearranged, and thus light transmittance of the liquid crystal layer is adjusted.

Such a liquid crystal display includes a liquid crystal panel and a backlight assembly. The liquid crystal panel includes a pair of substrates with a liquid crystal layer interposed therebetween, and the backlight assembly emits light that passes through the liquid crystal panel. The backlight assembly includes a plurality of lamps, various optical sheets, a diffusion plate, and a case for housing the aforementioned elements.

In liquid crystal displays, a diffusion plate is disposed above a plurality of lamps and a liquid crystal panel is disposed above the diffusion plate. Heat generated by the lamps is transferred to the liquid crystal panel through the diffusion plate. When heat with high energy is transferred to the liquid crystal panel, an erroneous operation occurs in the liquid crystal panel and thus the display characteristic of the liquid crystal display is degraded. For this reason, in order to improve the display characteristic of a liquid crystal display, it is required to prevent heat generated by a lamp from being transferred to a liquid crystal panel.

### BRIEF SUMMARY OF THE INVENTION

An exemplary embodiment provides a hybrid diffusion plate that can prevent heat generated by lamps from being transferred to a liquid crystal panel, thereby improving luminance and elimination of bright lines.

An exemplary embodiment provides a backlight assembly that includes such a hybrid diffusion plate.

An exemplary embodiment provides a liquid crystal display that includes such a backlight assembly.

In an exemplary embodiment, a hybrid diffusion plate includes a plurality of sub diffusion plates facing one another and diffusing light, heat-insulating layers having heat conductivity lower than the sub diffusion plates and respectively interposed between each pair of adjacent sub diffusion plates, and a sealant applied between each pair of adjacent sub diffusion plates along an edge and bonding the sub diffusion plates to each other.

In an exemplary embodiment, a backlight assembly includes a light source, a hybrid diffusion plate disposed above the light source so as to diffuse light generated by the lamps and a case housing the light source and the hybrid diffusion plate. The hybrid diffusion plate includes a plurality of sub diffusion plates facing one another and diffusing light, heat-insulating layers having heat conductivity lower than the sub diffusion plates and being respectively interposed between each pair of adjacent sub diffusion plates, and a sealant applied between each pair of adjacent sub diffusion plates along an edge and bonding the sub diffusion plates to each other.

In an exemplary embodiment, a liquid crystal display includes a liquid crystal panel displaying image information and a backlight assembly which supplies light to the liquid crystal panel. The backlight assembly includes a light source, a hybrid diffusion plate disposed above the light source so as to diffuse light generated by the light source and a case housing the light source and the hybrid diffusion plate.

An exemplary embodiment provides a method of forming a hybrid diffusion plate. The method includes disposing a plurality of sub diffusion plates facing each other, interposing a heat insulating layer between each pair of adjacent sub diffusion plates, and applying a sealant between each pair of adjacent sub diffusion plates along an edge to bond the sub diffusion plates to each other. The heat insulating layer includes a heat conductivity lower than the sub diffusion plates.

### BRIEF DESCRIPTION OF THE DRAWINGS

The above and other features and advantages of the invention will become more apparent by describing in detail embodiments thereof with reference to the attached drawings, in which:

FIG. 1 is an exploded perspective view showing an exemplary embodiment of a liquid crystal display according to the invention;

FIG. 2 is an exploded perspective view showing a hybrid diffusion plate shown in FIG. 1;

FIG. 3 is a cross-sectional view of the hybrid diffusion plate shown in FIG. 2 taken along line B-B′;

FIG. 4 is a cross-sectional view taken along line A-A′ after the components of the liquid crystal display shown in FIG. 1 are combined;

FIG. 5A is a cross-sectional view of another exemplary embodiment of a hybrid diffusion plate according to the invention;

FIGS. 5B to 5E are views showing alternative exemplary embodiments of the hybrid diffusion plate shown in FIG. 5A;

FIG. 6 is a view showing another exemplary embodiment of the hybrid diffusion plate shown in FIG. 2; and

FIG. 7 is a cross-sectional view of the hybrid diffusion plate shown in FIG. 6 taken along the line C-C′.

### DETAILED DESCRIPTION OF THE INVENTION

Advantages and features of the invention and methods of accomplishing the same may be understood more readily by reference to the following detailed description of preferred embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

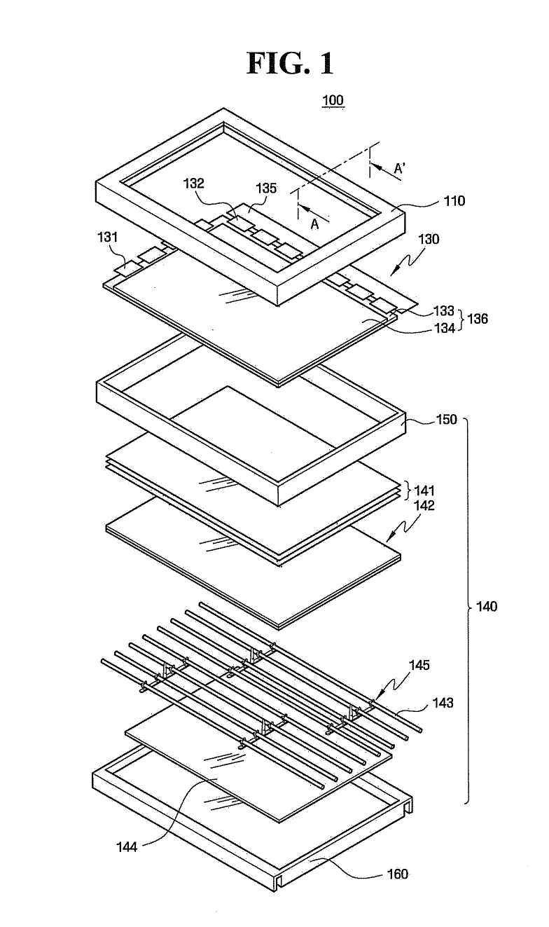

Hereinafter, exemplary embodiments of a hybrid diffusion plate according to the invention, a backlight assembly including the hybrid diffusion plate, and a liquid crystal display including the backlight assembly will be described in detail with reference to FIGS. 1 to 5A.

FIG. 1 is an exploded perspective view showing an exemplary embodiment of a liquid crystal display according to the invention. Referring to FIG. 1, a liquid crystal display 100 includes a liquid panel assembly 130 that displays image information, a backlight assembly 140 that emits light to the liquid panel assembly 130, and an upper case 110 that is combined with the backlight assembly 140 to hold the liquid panel assembly 130.

The liquid panel assembly 130 includes a liquid crystal panel 136 including a thin film transistor display panel 133 (hereinafter, a thin film transistor will be referred to as a TFT) and a common electrode display panel 134, liquid crystal (not shown), a plurality of gate tape carrier packages 131, a plurality of data tape carrier packages 132 and a printed circuit board 135.

In the liquid crystal panel 136, the TFT display panel 133 includes gate lines (not shown), data lines (not shown), a TFT array (not shown), pixel electrodes (not shown), and the like, and the common electrode display panel 134 includes a black matrix (not shown), a common electrode (not shown), and the like and is disposed to face the TFT display panel 133.

The gate tape carrier packages 131 are connected to the gate lines (not shown) formed on the TFT display panel 133 and the data tape carrier packages 132 are connected to the data lines (not shown) formed on the TFT display panel 133.

On the printed circuit board 135, various driving components for processing gate driving signals and data driving signals, which are input to the gate tape carrier packages 131 and the data tape carrier packages 132, respectively, are mounted.

The backlight assembly 140 includes optical sheets 141, a hybrid diffusion plate 142, a plurality of lamps 143 used a light source, a reflecting plate 144, and a frame 150 and a lower case 160 for holding them.

In one exemplary embodiment, a CCFL (Cold Cathode Fluorescent Lamp) or an EEFL (External Electrode Fluorescent Lamp) may be used as the lamp 143. When a lamp driving voltage is applied to the lamp 143 from an outside, the lamp 143 emits light. The lamps 143 are connected in parallel at substantially regular intervals on the same plane and serve as a direct-type backlight. In order to uniformly distribute a discharge gas in the lamp 143 so as to achieve uniform luminance, the lamps 143 may be disposed substantially in parallel with the liquid crystal panel 136. The lamp driving voltage is applied to both ends of each lamp 143. At both ends of each lamp 143, lamp sockets (not shown) may be formed to support and fix the lamp 143. Further, a light emitting diode (“LED”) may be used as a light source. In the illustrated exemplary embodiment, a plurality of lamps are used as a light source.

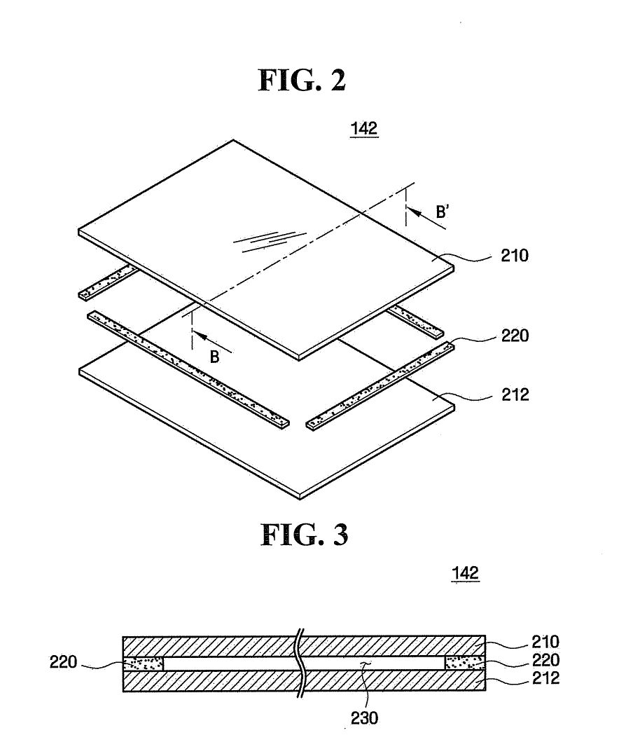

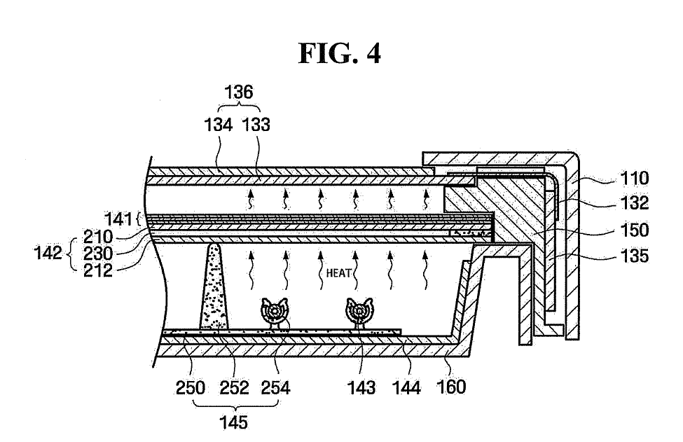

The hybrid diffusion plate 142 is disposed above the lamps 143. The function of the hybrid diffusion plate 142 is to improve uniformity in luminance of light generated by the lamps 143 and to reduce or effectively prevent heat generated by the lamps 143 from being transferred to the liquid crystal panel 136. Hereinafter, an exemplary embodiment of a hybrid diffusion plate according to the invention will be described in detail with reference to FIGS. 2 and 3. FIG. 2 is an exploded perspective view of the hybrid diffusion plate shown in FIG. 1, and FIG. 3 is a cross-sectional view of the hybrid diffusion plate shown in FIG. 2 taken along line B-B′.

As shown in FIGS. 2 and 3, the hybrid diffusion plate 142 according to an embodiment of the invention includes first and second sub diffusion plates 210 and 212 that are disposed to face each other, and a heat-insulating layer 230 having a low refraction index.

In an exemplary embodiment, each of the first and second sub diffusion plates 210 and 212 may be formed of a transmissive resin layer including a diffusing agent. The diffusing agent may include, but is not limited to, a silicon diffusing agent, a magnesium diffusing agent, a calcium oxide diffusing agent, and the like. The transmissive resin layer may include, but is not limited to, PMMA (polymetylmethacrylate), MS (metylstyrene), PS (polystyrene), PC (polycarbonate),and the like. When light passes through the first and second sub diffusion plates 210 and 212, uniformity in luminance of light can be improved.

The heat-insulating layer 230 preferably has heat conductivity and a refraction index lower than the first and second sub diffusion plates 210 and 212. In one exemplary embodiment, a layer of air having the lowest heat conductivity and the lowest refraction index may be used as the heat-insulating layer 230. Air has the heat conductivity of about 0.026 kcal/m·h·° C. and the refraction index of about 1, which are much lower than the first and second sub diffusion plates 210 and 212. In the illustrated embodiment, the layer of air is used as the heat-insulating layer 230. However, the invention is not limited thereto. Any of a number of materials may be used insofar as it has heat conductivity and a refraction index lower than the first and second sub diffusion plates 210 and 212.

The first sub diffusion plate 210 and the second sub diffusion plate 212 are bonded to each other by a sealant 220 interposed therebetween along edges (e.g., peripheral edges) of the first sub diffusion plate 210 and the second sub diffusion plate 212. The sealant 220 may be formed of the same material as the first and second sub diffusion plates 210 and 220 or a material different from the first and second sub diffusion plates 210 and 220. In one exemplary embodiment, the sealant 220 may be formed of a double-sided tape, a gluing agent, a bonding agent or the like. Alternatively, where a resin layer formed of the same material as the sub diffusion plates 210 and 212 is used as the sealant 220, heat welding may be used to melt the sealant 220, such that the first and second sub diffusion plates 210 and 212 are bonded to each other.

Since the heat-insulating layer 230 has heat conductivity different from the first and second sub diffusion plates 210 and 212, the sealant 220 may be formed leaving an opening so as to expose the heat-insulating layer 230 to the outside. The opening may be essentially used as an air circulation path. Further, at least one hole used as an air circulation path may be formed around the edge of the first sub diffusion plate 210 or the second sub diffusion plate 212. Air in the heat-insulating layer 230 may proceed or move toward the outside through the air circulation path.

Referring to FIG. 1 again, the reflecting plate 144 is disposed below the lamps 143 and reflects light emitted below the lamps 143 upward (e.g., towards the liquid crystal panel 136. A bottom surface of the lower case 160 may be formed of a reflective material and used as the reflecting plate 144. In one exemplary embodiment, the lower case 160 may be formed of aluminum (Al) or an aluminum alloy having high reflectance such that the lower case 160 itself serves as the reflecting plate 144.

The lamps 143 are fixed by a plurality of lamp fixing units 145 disposed on the reflecting plate 144 and/or attached to the lower case 160.

The optical sheets 141 are disposed on the hybrid diffusion plate 142 and diffuse and concentrate light emitted from the lamps 143. In one exemplary embodiment, the optical sheets 141 may include, but are not limited to, a diffusion sheet, a first prism sheet, a second prism sheet, and the like.

The diffusion sheet is disposed directly above the lamps 143 and improves luminance of light incident thereon and uniformity in luminance.

The first prism sheet is disposed on the diffusion sheet. On a surface of the first prism sheet, a plurality of prism patterns (not shown) for concentrating light diffused by the diffusion sheet and emitting concentrated light may be substantially regularly formed. The prism pattern may have a triangular prism shape. In an exemplary embodiment, a brightness enhancement film may be used as the first prism sheet.

The second prism sheet is disposed on the first prism sheet and may be a reflective polarizing prism sheet having a multi-layer structure, which concentrates light, polarizes concentrated light, and emits polarized light. In one exemplary embodiment, a dual brightness enhancement film may be used as the second prism sheet. If satisfactory luminance and viewing angle is secured by using only the first prism sheet, the second prism sheet may be omitted.

The various types of optical sheets 141 depend on the specification of the backlight assembly 140.

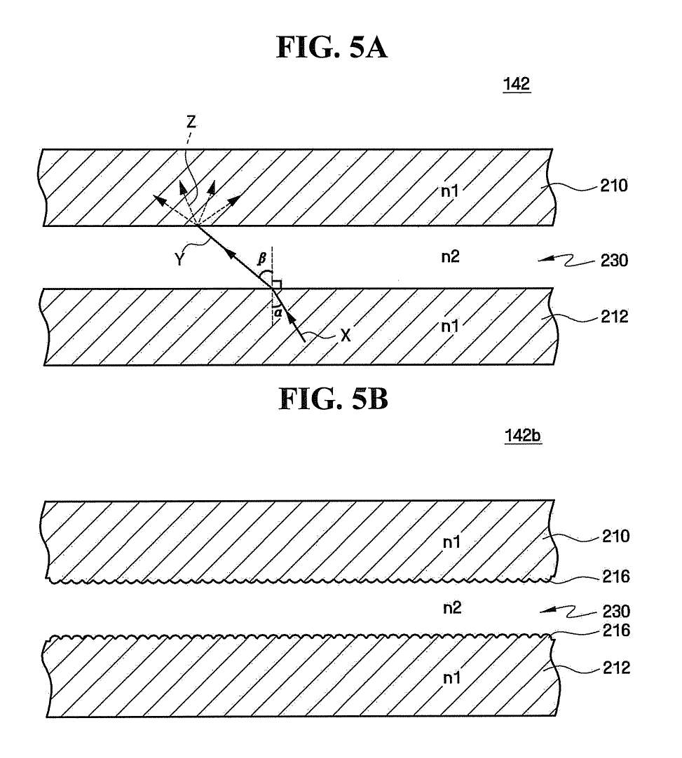

The reflecting plate 144, the lamps 143, the hybrid diffusion plate 142, and the optical sheets 141 are sequentially put in the lower case 160. The frame 150 is combined to the lower case 160. Hereinafter, a connection relationship between the components of the liquid crystal display of the illustrated embodiment will be described with reference to FIGS. 1 and 4. FIG. 4 is a cross-sectional view taken along line A-A′ after the components of the liquid crystal display shown in FIG. 1 are combined.

As shown in FIGS. 1 and 4, the liquid crystal panel 136 is disposed on the optical sheets 141 while being supported by the frame 150. The frame 150 is formed of sidewalls formed along the edges of a rectangle shape and steps or protrusions are formed on the inner sides of the sidewalls so as to support the liquid crystal assembly 130.

The lower case 160 is formed of a substantially rectangular flat portion and sidewalls, which are formed along edges of an upper surface of the flat portion, so as to hold the reflecting plate 144, the lamps 143, the hybrid diffusion plate 142 and the optical sheets 141.

The lamp fixing units 145 not only have the function of fixing the lamps 143 but also a function of supporting the hybrid diffusion plate 142 and the optical sheets 141 so as to reduce or prevent bending of the hybrid diffusion plate 142 and the optical sheets 141.

The lamp fixing unit 145 includes a plate 250 disposed on the reflecting plate 144, a plurality of grippers 254 formed on the plate 250 to fix the lamps 143, and a supporter 252 formed on the plate 250 to support the hybrid diffusion plate 142. On a lower surface of the plate 250, a plurality of hooks (not shown) may be formed. The hooks pass through the reflecting plate 144 and are joined with openings (not shown) formed at the bottom surface of the lower case 160, thereby fixing the lamp fixing unit 145 to the lower case 160.

The data tape carrier packages 132 are bent along an outer wall of the lower case 160. The printed circuit board 135 of the liquid panel assembly 130 is securely attached to a sidewall and/or a rear surface of the lower case 160. The shape of the lower case 160 may be modified according to a method of putting the optical sheets 141, the hybrid diffusion plate 142, the lamps 143, and the reflecting plate 144 in the lower case 160.

The upper case 110 is combined with the lower case 160 to cover the upper surface of the liquid panel assembly 130 disposed in the frame 150. A window is formed in the upper surface of the upper case 110 to expose the liquid panel assembly 130 to the outside.

In an exemplary embodiment, the upper case 110 is combined with the lower case 160 by hooking or screwing.

Hereinafter, a process of preventing heat generated by the lamps 143 from being transferred to the liquid crystal panel 136 will be described in detail with reference to FIG. 4.

Heat generated by the lamps 143 (indicated by the upward arrows) is transferred to the hybrid diffusion plate 142 by thermal radiation. The heat generated by the lamps 143 heats air in the space defined by the lower case 160 and the hybrid diffusion plate 142 and is transferred to the hybrid diffusion plate 142 by air convection. The heat transferred to the hybrid diffusion plate 142 is then transferred to the optical sheets 141. The heat transferred to the optical sheets 141 is then transferred to the liquid crystal panel 136 by thermal radiation and convection (as indicated by the arrows).

As in the illustrated embodiment where the hybrid diffusion plate 142 is used, when the heat-insulating layer 230 having heat conductivity lower than the first and second sub diffusion plates 210 and 212 is disposed between the first and second sub diffusion plates 210 and 212 formed of the resin, heat conductivity is reduced. Advantageously, the heat transferred through the hybrid diffusion plate 142 is insulated and as a result, the overall temperature of the liquid crystal panel 136 is prevented from rising.

Alternative, where an air layer is used as the heat-insulating layer 230, the heat transferred from the lamps 143 to the hybrid diffusion plate 142 is transferred through the second sub diffusion plate 212 and then is transferred to the first sub diffusion plate 210 by thermal radiation and convection in the air layer. Since thermal radiation and convection exhibit considerably low heat conductivity compared with heat conduction, the heat conductivity of the hybrid diffusion plate 142 can be further reduced.

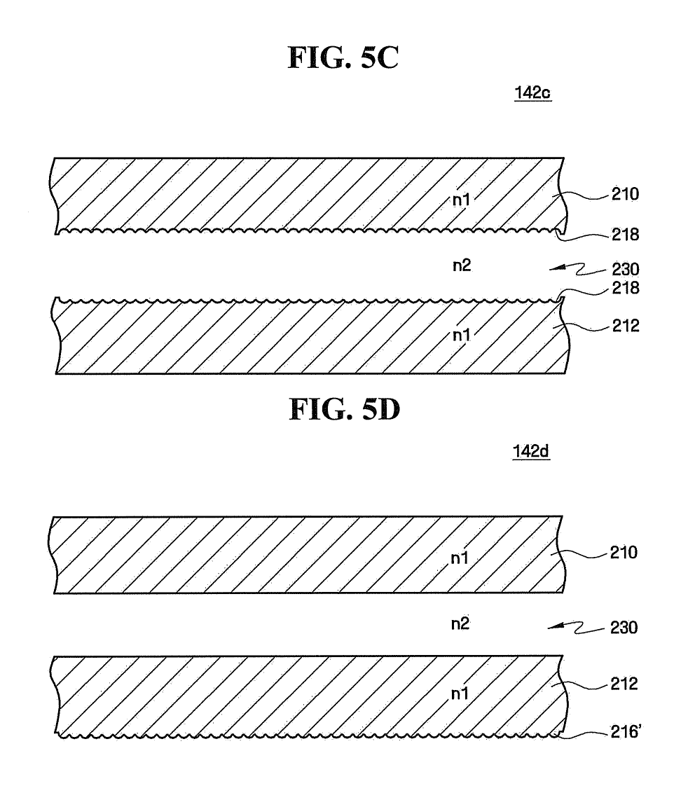

An exemplary embodiment of a process of improving luminance of the liquid crystal display according to the invention and removing bright lines will be described in detail with reference to FIGS. 4 and 5A. FIG. 5A is a cross-sectional view of another exemplary embodiment a hybrid diffusion plate according to the invention.

Referring to FIGS. 4 and 5A, light generated by the lamps 143 is transferred to the liquid crystal panel 136 through the hybrid diffusion plate 142. Light is infrequently absorbed by the air layer but is absorbed by the sub diffusion plates 210 and 212 which are formed of the resin. When the thickness of the hybrid diffusion plate 142 is substantially uniform and an air layer is used as the heat-insulating layer 230, the distance of light passing through the resin layers is shortened. As in the illustrated embodiment, a relatively small amount of light generated by the lamps 143 is absorbed by the hybrid diffusion plate 142 and thus luminance of the liquid crystal display can be increased.

A liquid crystal display using a plurality of lamps 143 as a light source may be required in order to remove bright lines such that a user cannot recognizes the shapes of the lamps 143.

In an illustrated embodiment, the heat-insulating layer 230 having a refraction index lower than the first and second sub diffusion plates 210 and 212 is disposed between the first and second sub diffusion plates 210 and 212. Each of the first and second sub diffusion plates 210 and 212 may include a diffusing agent for diffusing light. Advantageously, the hybrid diffusion plate 142 can effectively remove bright lines.

In FIG. 5A, n1 denotes the refraction indexes of the first and second sub diffusion plates 210 and 212, n2 denotes the refraction index of the heat-insulating layer 230, α denotes the incident angle of light X that is incident on the heat-insulating layer 230 from the second sub diffusion plate 212, and β denotes the refraction angle of light Y that is refracted from the second sub diffusion layer 212 to the heat-insulating layer 230.

According to the Snell's law, sin α/sin β=n2/n1. In the above-mentioned case, since n2<n1, sin α<sin β, and accordingly, α<β. When the heat-insulating layer 230 has a refraction index lower than the second sub diffusion layer 212, the incident angle of light X is larger than the refraction angle of light Y. When light generated by the lamps 143 passes through the heat-insulating layer 230 via the second sub diffusion layer 212, light is emitted essentially sideward at an angle larger than when light is emitted from the lamps 143. Light Z that is refracted from the heat-insulating layer 230 to the first sub diffusion layer 210 is diffused in the first sub diffusion layer 210. Advantageously, bright lines are removed.

Hereinafter, alternative exemplary embodiments of the hybrid diffusion plate with an enhanced diffusing function will be described with reference to FIGS. 5B to 5E. FIGS. 5B to 5E are views showing alternative exemplary embodiments of the hybrid diffusion plate shown in FIG. 5A.

In a hybrid diffusion plate 142b shown in FIG. 5B, in order to enhance the diffusing function, convex diffusing patterns 216 are formed at surfaces, e.g., adjacent to a heat-insulating layer 230, of each of the first and second sub diffusion layers 210 and 212, respectively. The convex diffusing pattern 216 may be substantially round shaped, but is not limited thereto. In FIG. 5B, the convex diffusing patterns 216 are formed in both of the first and second sub diffusion layers 210 and 212. However, the invention is not limited thereto. Alternatively, the convex diffusing patterns 216 may be formed on any one of the first and second diffusion layers 210 and 212.

A hybrid diffusion plate 142c shown in FIG. 5C is different from the hybrid diffusion plate 142b in that concave diffusing patterns 218 are formed, instead of the convex diffusing patterns 216 of FIG. 5B. The concave diffusing pattern 218 may be substantially round shaped, but are not limited thereto. In FIG. 5C, the concave diffusing patterns 218 are formed in both of the first and second sub diffusion layers 210 and 212. However, the invention is not limited thereto. Alternatively, the concave diffusing patterns 218 may be formed on any one of the first and second diffusion layers 210 and 212.

In alternative embodiments, it is possible to form convex diffusing patterns 216 and concave diffusing patterns 218 at the surfaces adjacent to the heat-insulating layer 230, of the first and second sub diffusion layers 210 and 212, respectively, or to form concave diffusing patterns 218 and convex diffusing patterns 216 at the surfaces adjacent to the heat-insulating layer 230, of the first and second sub diffusion layers 210 and 212, respectively.

In a hybrid diffusion plate 142d shown in FIG. 5D, in order to enhance the diffusing function, convex diffusing patterns 216′ are formed at the surface, adjacent to the lamps, of a second sub diffusion layer 212. The convex diffusing patterns 216′ may be substantially round shaped, but are not limited thereto. In a hybrid diffusion plate 142e shown in FIG. 5E, in order to enhance the diffusing function, concave diffusing patterns 218′ are formed at the surface adjacent to the lamps, of a second sub diffusion layer 212. The concave diffusing pattern 218′ may be substantially round shaped, but are not limited thereto.

Exemplary embodiments of hybrid diffusion plates in which various diffusing patterns 216, 216′, 218, and 218′ are formed in order to enhance the diffusing function have been described above with reference to FIGS. 5B to 5E. In the illustrated embodiments, for convenience of explanation, the diffusing patterns 216, 216′, 218, and 218′ has been individually described. However, any of a number of combinations of the diffusing patterns 216, 216′, 218, and 218′ may be formed in a hybrid diffusion plate. Hereinafter, for convenience of explanation, the description will be given by way of the hybrid diffusion plate shown in FIG. 5A.

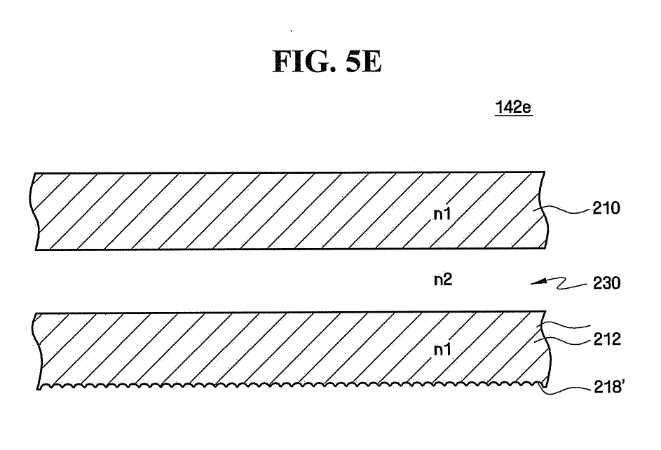

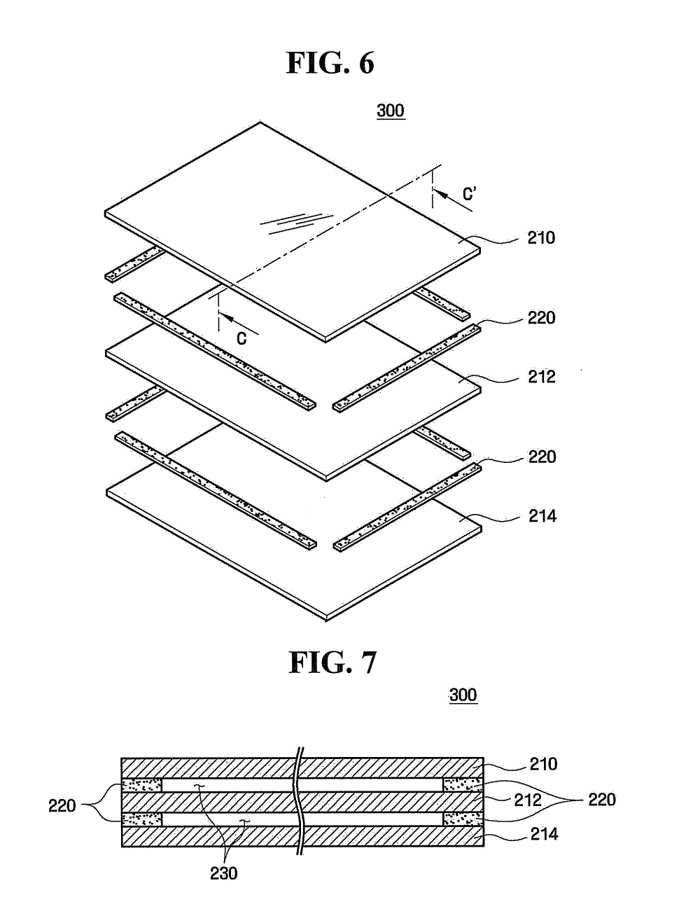

Hereinafter, another exemplary embodiment of a hybrid diffusion plate according to the invention will be described with reference to FIGS. 6 and 7. FIG. 6 is a view showing another exemplary embodiment of the hybrid diffusion plate shown in FIG. 2 and FIG. 7 is a cross-sectional view of the hybrid diffusion plate shown in FIG. 6 taken along line C-C′. For convenience of explanation, components having the same functions as those shown in FIGS. 1 to 5A are denoted by the same reference numbers and thus the descriptions thereof will be omitted. As shown in FIGS. 6 and 7, the hybrid diffusion plate has basically the same structure as the hybrid diffusion plate of FIGS. 1 and 5A except for the following parts.

As shown in FIGS. 6 and 7, a hybrid diffusion plate 300 includes first, second, and third sub diffusion plates 210, 212, and 214 that are disposed to face one another, and heat-insulating layers 230 that are respectively interposed between each pair of adjacent sub diffusion plates. A heat-insulating layer 230 is interposed between the first and second sub diffusion plates 210 and 212 and another heat-insulating layer 230 is interposed between the second and third sub diffusion plates 212 and 214. The hybrid diffusion plate 300 shown in FIG. 7 has the effects substantially identical to or superior to the hybrid diffusion plate 142 shown in FIG. 3.

In the illustrated embodiments, a hybrid diffusion plate includes two or three sub diffusion plates and heat-insulating layers are respectively interposed between each pair of adjacent sub diffusion plates. However, the invention is not limited thereto, but may be applied to a hybrid diffusion plate that includes four or more sub diffusion plates with heat-insulating layers respectively interposed between each pair of adjacent two sub diffusion plates.

Although the invention has been described in connection with the exemplary embodiments of the invention, it will be apparent to those skilled in the art that various modifications and changes may be made thereto without departing from the scope and spirit of the invention. Therefore, it should be understood that the above embodiments are not limitative, but illustrative in all aspects.

In the illustrated embodiments of the hybrid diffusion plate, the backlight assembly including the hybrid diffusion plate, and a liquid crystal display including the backlight assembly according to the invention, since the heat-insulating layer having low heat conductivity is formed in the hybrid diffusion plate, it is possible to effectively reduce or prevent heat generated by the lamps from being transferred to the liquid crystal panel.

Further, since the hybrid diffusion plate includes a plurality of sub hybrid diffusion plates and the heat-insulating layers respectively interposed between every two adjacent sub hybrid diffusion plates have a refraction index lower than the sub hybrid diffusion plates, light generated by the lamps is diffused even more and thus it is possible to remove bright lines.

What is claimed is:

1. A hybrid diffusion plate comprising:
a plurality of sub diffusion plates facing one another and diffusing light; heat-insulating layers having heat conductivity lower than the sub diffusion plates and being respectively interposed between each pair of adjacent sub diffusion plates; and
a sealant applied between each pair of adjacent sub diffusion plates along an edge of the sub diffusion plates, and bonding the sub diffusion plates to each other.

2. The hybrid diffusion plate of claim 1, wherein each of the heat-insulating layers has a refraction index lower than the sub diffusion plates.

3. The hybrid diffusion plate of claim 2, wherein the heat-insulating layers comprise an air layer.

4. The hybrid diffusion plate of claim 1, wherein the sealant is formed of a double-sided tape, a gluing agent or a bonding agent.

5. The hybrid diffusion plate of claim 1, wherein the sealant is formed of the same material as the sub diffusion plates and the sub diffusion plates are bonded to each other by the sealant melted by heat welding.

6. The hybrid diffusion plate of claim 1, wherein the sub diffusion plates comprise a transmissive resin layer including a diffusing agent.

7. The hybrid diffusion plate of claim 1, wherein diffusing patterns for enhancing a diffusing function are formed at one surface adjacent to the heat-insulating layers of each of the sub diffusion plates.

8. A backlight assembly comprising:
a light source;
a hybrid diffusion plate disposed above the light source and diffusing light generated by the light source, the hybrid diffusion plate comprising a plurality of sub diffusion plates facing one another and diffusing the light, heat-insulating layers having heat conductivity lower than the sub diffusion plates respectively interposed between each pair of adjacent sub diffusion plates, and a sealant applied between each pair of adjacent sub diffusion plates along an edge and bonding the sub diffusion plates to each other; and
a case housing the light source and the hybrid diffusion plate.

9. The backlight assembly of claim 8, wherein each of the heat-insulating layers has a refraction index lower than the sub diffusion plates.

10. The backlight assembly of claim 9, wherein the heat-insulating layers comprise an air layer.

11. The backlight assembly of claim 10, further comprising an air circulation path through which air in the air layer moves toward the outside.

12. The backlight assembly of claim 8, wherein the sealant is formed of a double-sided tap, a gluing agent or a bonding agent.

13. The backlight assembly of claim 8, wherein the sealant is formed of the same material as the sub diffusion plates and the sub diffusion plates are bonded to each other by the sealant melted by heat welding.

14. The backlight assembly of claim 8, wherein the sub diffusion plates comprise a transmissive resin layer including a diffusing agent.

15. The backlight assembly of claim 8, wherein diffusing patterns for enhancing a diffusing function are formed at a surface adjacent to the heat-insulating layer, of each of the sub diffusion plates.

16. The backlight assembly of claim 8, further comprising a plurality of lamp fixing units fixing the lamps and supporting the hybrid diffusion plate from below.

17. The backlight assembly of claim 8, wherein the light source comprises a light emitting diode.

18. The backlight assembly of claim 8, wherein the light source comprises a plurality of lamps.

19. A liquid crystal display comprising:
a liquid crystal panel displaying image information; and
a backlight assembly supplying light to the liquid crystal panel,
wherein the backlight assembly comprises:
a light source;
a hybrid diffusion plate disposed above the light source and diffusing light generated by the light source, the hybrid diffusion plate comprising a plurality of sub diffusion plates facing one another and diffusing the light, heat-insulating layers having heat conductivity lower than the sub diffusion plates respectively interposed between each pair of adjacent sub diffusion plates, and a sealant applied between each pair of adjacent sub diffusion plates along an edge and bonding the sub diffusion plates to each other; and
a case housing the light source and the hybrid diffusion plate.

20. A method of forming a hybrid diffusion plate, the method comprising:
disposing a plurality of sub diffusion plates facing each other;
interposing a heat insulating layer between each pair of adjacent sub diffusion plates; and
applying a sealant between each pair of sub diffusion plates along an edge to bond the sub diffusion plates to each other,
wherein the heat insulating layer includes a heat conductivity lower than the sub diffusion plates.
